(19) United States
(12) Patent Application Publication
(10) Pub. No.: US 2013/0175986 A1
(43) Pub. Date: Jul. 11, 2013

(54) WIRELESS ELECTRONIC DEVICE DOCKING SYSTEM

(71) Applicant: Mark David Senatori, The Woodlands, TX (US)

(72) Inventor: Mark David Senatori, The Woodlands, TX (US)

(73) Assignee: Hewlett-Packard Development Company ,L.P., Houston, TX (US)

(21) Appl. No.: 13/821,002

(22) PCT Filed: Oct. 6, 2010
(86) PCT No.: PCT/US2010/051600

§ 371 Date: Mar. 5, 2013

(51) Int. Cl. H02J 7/02

(52) U.S. Cl. CPC H02J 7/025
USPC 320/108; 320/137

(57) ABSTRACT

A wireless electronic device docking system includes an electronic device having a recessed area disposed on a working surface of the electronic device, the recessed area to receive a portable computer device. The docking system includes a wireless module to wirelessly charge the portable computer device when the portable computer device is disposed within the recessed area.

### BACKGROUND

Electronic devices, such as laptop or notebook computers, can communicate with portable computer devices such as portable music players. Portable computer devices may have rechargeable batteries which often can be charged by the electronic devices. Such functionality often requires a wired electrical connection between the portable computer devices and the electronic devices.

### BRIEF DESCRIPTION OF THE DRAWINGS

FIG. 1 is a block diagram of an electronic device employing an embodiment of a wireless docking system for a portable computer device.

FIG. 2 is an illustrative view of an electronic device employing an embodiment of a wireless docking system for a portable computer device of FIG. 1.

FIG. 3 is a flow diagram of an operation of the electronic device employing an embodiment of a wireless docking system for a portable computer device of FIG. 1.

### DETAILED DESCRIPTION OF THE DRAWINGS

Electronic devices, such as laptop or notebook computers, can communicate with and charge portable computer devices such as portable music players. However, such systems often require a wired (physical) electrical connection between the electronic devices and the portable computer devices. Such wired electrical connections may become prone to wear through frequent use and thereby reduce electrical connection reliability. Furthermore, the portable computer device and the electronic device may have to be aligned to provide proper communication. In one embodiment, disclosed is an electronic device with a wireless docking system that has a recessed area capable of receiving a portable computer device to wirelessly charge and wirelessly communicate with the portable computer device when the portable computer device is disposed in the recessed area. The use of wireless techniques may provide advantages. For example, such wireless techniques may reduce the need for physical electrical connections or alignment and therefore may increase the reliability of communication between the devices. Moreover, the wireless docking system can allow communication with any portable computer without requiring specific matching electrical connectors between devices Furthermore, the portable computer device may be operational even while the device is transported and disposed in the recessed area of the wireless docking system.

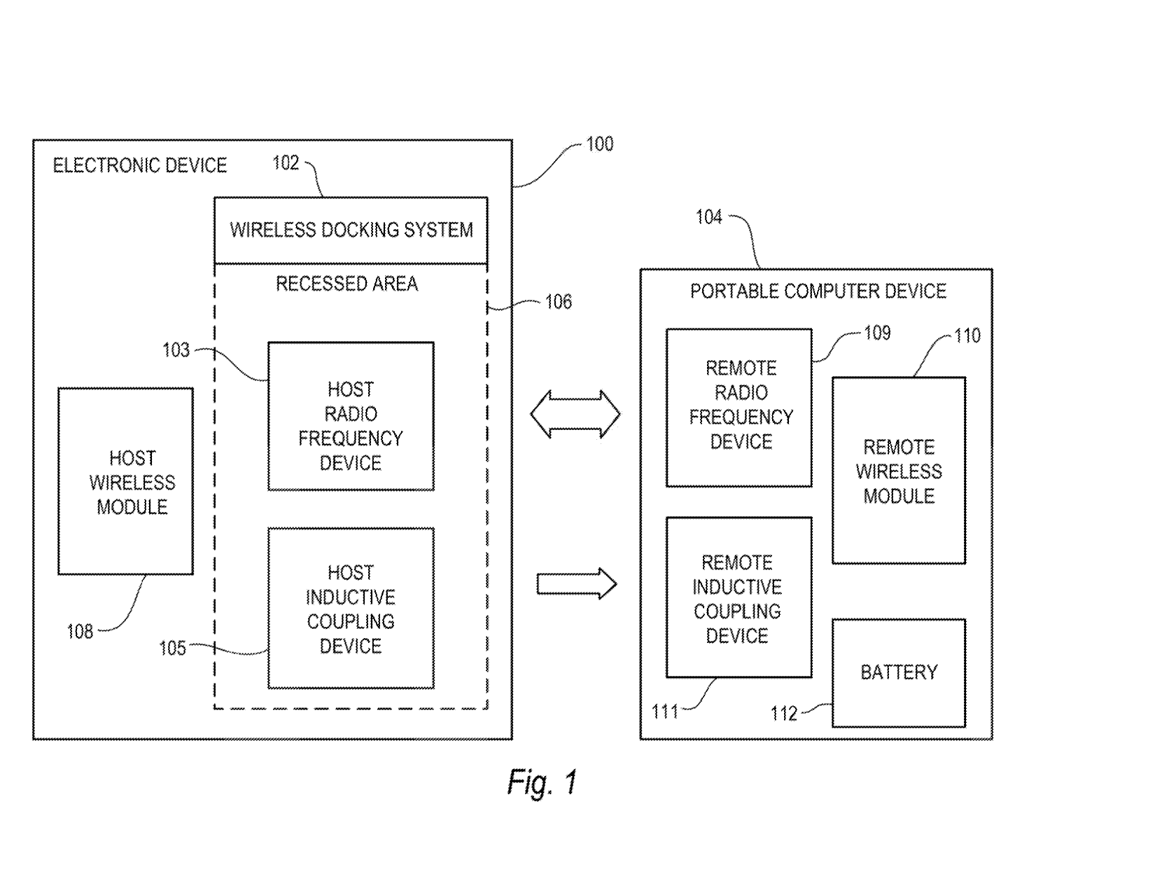

FIG. 1 is a block diagram illustrating an electronic device 100 in which an embodiment of a wireless docking system 102 is employed to advantage to receive a detachable portable computer device 104. The wireless docking system 102 includes a recessed area 106 configured to receive portable computer device 104. The electronic device 100 includes a host wireless module 108 configured to control the operation of a host radio frequency (RF) device 103 which facilitates wireless communication between electronic device 100 and portable computer device 104. The host wireless module 108 can control the operation of a host inductive coupling device 105 to facilitate wireless (inductive) charging of portable computer device 104 by electronic device 100.

In a similar manner, portable computer device 104 includes a remote wireless module 110 configured to control the operation of a remote RF device 109 which facilitates wireless communication between electronic device 100 and portable computer device 104. Likewise, remote wireless module 110 can control the operation of a remote inductive coupling device 111 to facilitate wireless (inductive) charging of portable computer device 104 by electronic device 100. The portable computer device 104 includes a battery 112 as a power source to power the device. The battery 112 can include one or more battery cells capable of being recharged. The remote wireless module 104 is configured to facilitate the charging of battery 112 through the use of remote inductive coupling device 111

In one embodiment, electronic device 100 can communicate with and charge portable computer device 104 when electronic device detects that portable computer device is disposed in recessed area 106.

The host wireless module 108 and remote wireless module 10 can be implemented in software, firmware, hardware, or a combination thereof. In one embodiment, host wireless module 108 and remote wireless module 110 can be implemented in software, as an executable program, and can be executed by a special or general purpose digital computer, such as a personal computer (e.g., a notebook computer), workstation, minicomputer, mainframe computer and the like. In one embodiment, host wireless module 108 can be configured to automatically detect when portable computer device 104 is disposed within recessed area 106 of wireless docking system 102. In response to such detection, host wireless module 108 can automatically enable host RF device 103 to facilitate wireless communication between electronic device 100 and portable computer device 104. Furthermore, host wireless module 108, in response to such detection, can automatically enable host inductive coupling device 105 to facilitate wireless (inductive) charging of portable computer device 104. Such detection can be implemented in accordance with wireless communication interfaces such as Bluetooth®. Wi-Fi™ and the like. In other embodiments, host wireless module 108 and remote wireless module 110 can be configured to manually enable wireless communication between the devices as well as charging of portable computer device 104. In one embodiment, wireless module 108 can receive and process data from portable computer device 104. In another embodiment, wireless module 108 can transmit data in a wireless manner from electronic device 100 to portable computer device 104. In another embodiment, wireless module 108 can transmit data to portable computer device 104 as well as receive data from portable computer 104. Thus, electronic device 100 is capable of wireless communication with and wireless charging of portable computer device 104 when portable computer device is disposed in recessed area 106.

In another embodiment, host wireless module 108 can be configured to allow portable computer device 104 to use functionality of electronic device 100. For example, electronic device 100 may allow portable computer 104 to communicate with application programs which are deployed on electronic device. The electronic device can receive from portable computer device 104 media content (audio, music, video, etc) and then forward the media content to media applications executing on electronic device 100. The media application can included functionality to display video content, play audio content and the like. In another example, electronic device can include an application program to receive media content and forward the media content to portable computer device. The application programs can allow portable computer device 104 to exchange media content with other devices over communication networks such as the Internet. In this manner, media content can be exchanged between portable computer device 104 and electronic device 100 to provide an enhanced user experience. In another embodiment, electronic device 100 may be configured to allow computer device 104 to control the operation of the electronic device. For example, computer device 104 can be a remote control device which can control media aspects (audio, video, music, etc) of electronic device 100. The computer device 104 can, for instance, control the volume and/or selection of music content and/or video content being played on electronic device 100.

In other embodiments, electronic device 100 can be configured to automatically charge portable computer device 104 and establish a communication link with portable computer device to allow the exchange of data between the devices in a seamless manner. For example, once portable computer device 104 is disposed in recessed area 106 and electronic device 100 detects the presence of portable computer device in the recessed area, the electronic device can initiate wireless charging of the portable computer device, while at the same initiate a communication link with the portable computer device. Such a communication link can be established by host wireless module 108 and remote wireless module 110 to allow electronic device 100 to receive data from portable computer device 104. For example, the communication link can allow portable computer device 104 to send multi-media content such as image data to electronic device 100 which can then display the image data on the display of the electronic device. In another example, the communication can allow electronic device 100 to transmit data to portable computer device 104. In another embodiment, the communication link can also facilitate “drag and drop” operations between the devices such as, for example, “drag and drop” files between the devices, play files directly off the device and the like. In another example, the communication link can permit application programs residing on electronic device 100 to manipulate files that may be residing on portable computer device 104. In this manner, the communication link between electronic device 100 and portable computer device 104 may allow the portable device to become an extension of the electronic device and vice versa. For instance, portable computer device 104 may include phone functionality and allow a user to dial a telephone number on the screen of the phone. In this case, the communication link between the devices may allow the user to establish the phone call using resources of electronic device 100 such as a microphone and speakers, and possibly use the screen and webcam to see the person the user is communicating with.

The host RF device 103 and remote RF device 109 can be implemented in hardware, software, or combination thereof capable of wireless communication. For example, host RF device 103 and remote RF device 109 can be, but not limited to, an RF transmitter, RF receiver, RF transceiver, among others. Wireless communication can be implemented using any wireless protocol, interface, standard and the like. For example, wireless communication can implemented using Bluetooth® which is an open wireless technology standard for exchanging data over short distances (using short wavelength radio transmissions) from fixed and mobile devices, creating personal area networks (PANs) with high levels of security. In another example, wireless communication can be implemented using Wi-Fi™ which includes a wireless local area network (WLAN) device based on the IEEE 802.11 standards.

The host inductive coupling device 105 and remote inductive coupling device 111 can be implemented using any technology capable of employing an electromagnetic field to transfer energy between a host device as the transmitter (source) of the charging signal and a remote device as the receiver of the charging signal to charge its rechargeable power source such as a battery. For example, host inductive coupling device 105 can include a primary coil and remote inductive coupling device 111 can include a secondary coil. In operation, host inductive coupling device 105 can generate an electromagnetic field through the primary coil which causes a current to be generated (induced) in the secondary coil if the primary coil and the secondary coil are sufficiently proximate to each other to facilitate inductive coupling. The remote inductive coupling device 111 can convert the current to electrical power for charging battery 112. When the primary coil and the secondary coil are in close proximity to each other, the transfer of electrical energy is facilitated. That is, a small gap between the two coils facilitates inductive charging as a means of short-distance wireless energy transfer. In another embodiment, host inductive coupling device 105 can include an embedded antenna (not shown) and circuitry configured to generate RF signals. In a complementary manner, remote inductive coupling device 111 can include an embedded antenna and circuitry to detect the presence of external RF signals and convert the signals to electrical energy for use in charging battery 112. The use of inductive power to charge a battery is sometimes referred to as wireless charging or contact-less charging. It can provide a safe method of providing power because there are no direct electrical connections needed to transfer power. The charging techniques are described in the context of electromagnetic fields, however, it should be understood that other wireless charging techniques can be used such as RF, microwave, magnetic resonance and the like.

In one embodiment, host wireless module 108 and remote wireless module 110 can be implemented in software, as an executable program, and executable by a processor. In one embodiment, host wireless module 108 and remote wireless module 110 can be implemented in hardware which can be any combination of the following technologies which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA) and the like.

Although not shown to simplify the drawings, both electronic device 100 and portable computer device 104 can include a processor, memory and input/output (I/O) devices capable of communication via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include addresses, controls, and/or data connections to enable appropriate communications among the aforementioned components.

The processor can be any hardware device for executing software, particularly that stored in memory. The processor can be any custom made or commercially available processor, a central processing unit (CPU), an auxiliary processor among several processors associated with electronic device 100, a semiconductor based microprocessor (in the form of a microchip or chip set), a macroprocessor, or generally any device for executing software instructions. The I/O devices may include input devices, for example but not limited to, a keyboard, mouse, scanner, microphone, touch pad, touch screen, voice input and the like. Furthermore, the I/O devices may also include output devices, for example but not limited to, a printer, display. etc. Finally, the I/O devices may further include devices that communicate both inputs and outputs, for instance but not limited to, a modulator/demodulator (modem; for accessing another device, system, or network), a radio frequency (RF) device or other transceiver, a telephonic interface, a bridge, a router, etc. The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.), Moreover, the memory may incorporate electronic, magnetic, optical, and/or other types of storage media. The memory can have a distributed architecture, where various components are situated remote from one another, but can be accessed by the processor,

The software in memory may include one or more separate programs, each of which comprises an ordered listing of executable instructions for implementing logical functions. The software in the memory may include software to implement host wireless module and remote wireless module as well as an operating system (O/S). The OS can control the execution of other computer programs, such as host wireless module 108 and remote wireless module 110, and provide scheduling, input-output control, file and data management, memory management, and communication control and related services. Each of the host wireless module 108 and remote wireless module 110 can be a source program, executable program (object code), script, or any other entity comprising a set of instructions to be performed. When it is a source program, then the program needs to be translated via a compiler, assembler, interpreter, or the like, which may or may not be included within the memory, so as operate properly in connection with the OIS. Furthermore, host wireless module 108 and remote wireless module 110 can be written as (a) an obⱼect oriented programming language, which has classes of data and methods, or (b) a procedure programming language, which has routines, subroutines, and/or functions, for example but not limited to, C, C++ and Java. In some embodiments, the software in memory may further include a basic input output system (BIOS). The BIOS can include a set of essential software routines that initialize and test hardware at startup, start the O/S, and support the transfer of data among the hardware devices. The BIOS can be stored in ROM so that the BIOS can be executed when electronic device 100 is activated.

When electronic device 100 and portable computer device 104 are in operation, the processor can be configured to execute software stored within the memory, to communicate data to and from the memory, and to generally control operations of electronic device 100 pursuant to the software. The host wireless module 108 and remote wireless module 110 and the O/S, in whole or in part, but typically the latter, can be read by the processor, perhaps buffered within the processor, and then executed.

When host wireless module 108 and remote wireless module 110 are implemented in software, the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The host wireless module 108 and remote wireless module 110 can he embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

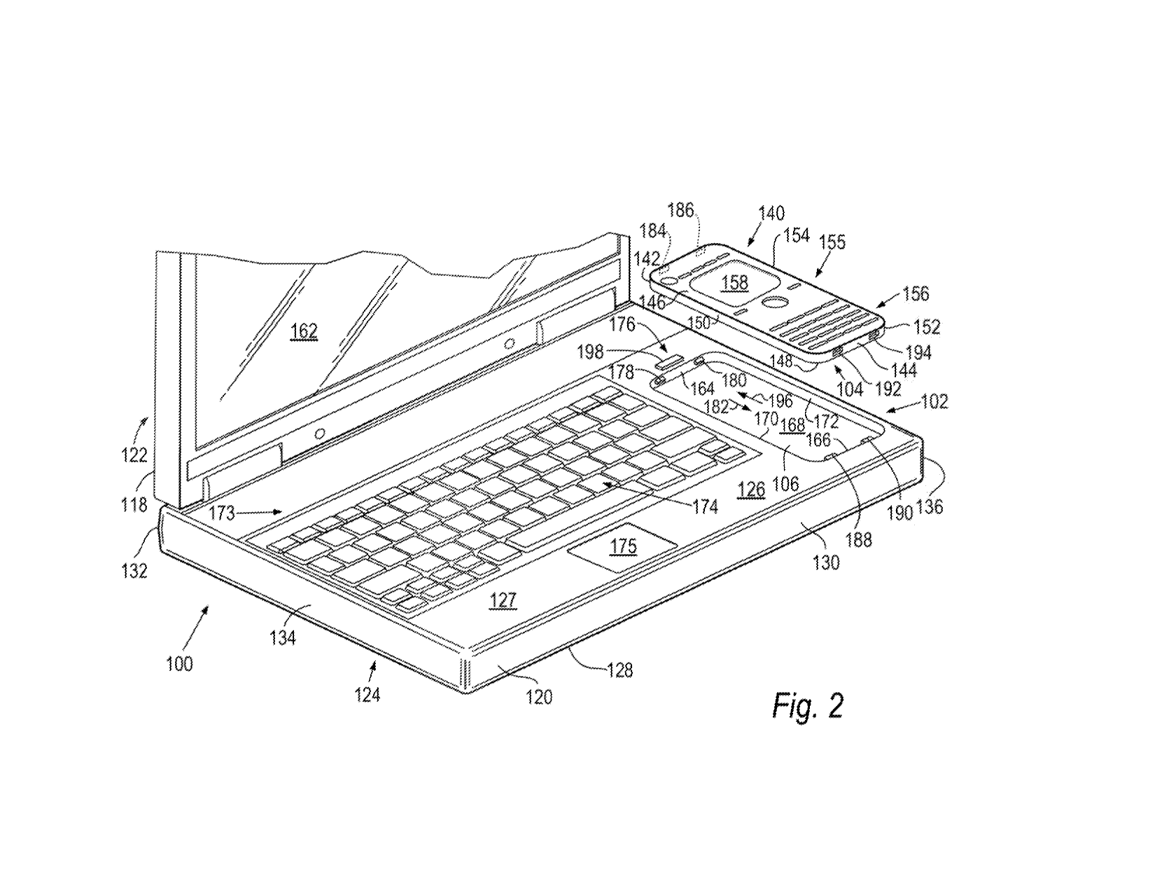

FIG. 2 is an illustrative view of electronic device 100 in which an embodiment of wireless docking system 102 is employed to advantage to receive detachable portable computer device 104. In the embodiment illustrated in FIG. 2, electronic device 100 comprises a laptop or notebook computer; however, it should be understood that electronic device 100 may comprise any type of electronic device such as, but not limited to, a tablet personal computer, a personal digital assistant, a gaming device, or any other type of portable or non-portable electronic device. In the embodiment illustrated in FIG. 2, electronic device 100 comprises a display member 118 rotatably coupled to a base member 120. Display member 118 and base member 120 each comprise a housing 122 and 124, respectively, formed having a number of walls. For example, housing 124 comprises a top wall 126 forming a working surface 127, a bottom wall 128, a front wall 130, a rear wall 132 and a pair of sidewalls 134 and 136. In the embodiment illustrated in FIG. 2, top wall 126 comprises a plurality of input interfaces 173 comprising an alphanumeric keyboard 174 and a touchpad 175.

In the embodiment illustrated in FIG. 2, recessed area 106 is disposed on top wall 126 and configured to receive and/or otherwise store portable computer device 104. In the embodiment illustrated in FIG. 2, portable computer device 104 is a portable music player comprising housing 140 having walls 142, 144, 146, 148, 150 and 152. In FIG. 2, portable computer device 104 includes input interfaces 155 such as an alphanumeric keypad 156 and a touch screen 158. It should be understood, however, that portable computer device 104 may be any type of device such capable of being disposed in recessed areas 106 such as, but not limited to, a gaming device, smart phone, or a personal data assistant.

In the embodiment illustrated in FIG. 2, recessed area 106 is formed by walls 164, 166, 168, 170 and 172. According to some embodiments, recessed area 106 is sized such that wall 146 of portable computer device 104 is flush (flush or substantially flush) with top wall 126 of electronic device 100 when portable computer device 104 is disposed in recessed area 106 to enable device 104 to be disposed within recessed area 106 while electronic device 100 is in the closed position. It should be understood that portable computer device 104 may also reside in recessed area 106 in a non-flush condition (e.g., such that a recess or other area in display member 118 receives at least a portion of portable computer device 104 when electronic device 100 is in a closed position). As used herein, a “closed position” of electronic device 100 shall mean when display member 118 is located in a position substantially parallel and/or coplanar with base member 120 such that display member 118 is disposed in contact with or directly adjacent to top wall 126 of electronic device 100. Furthermore, in the embodiment illustrated in FIG. 2, recessed area 106 is disposed on top wall 126 adjacent to keyboard 174 to enable portable computer device 104 to be readily available/usable to a user when disposed within recessed area 106. For example, in the embodiment illustrated in FIG. 2, recessed area 106 is disposed on top wall 126 near or otherwise adjacent to sidewall 136; however, it should be understood that top wall 126 may be otherwise configured such that recessed area 106 is near or otherwise adjacent to sidewall 134, front wall 130 and/or rear wall 132. it should be understood that electronic device 100 may be otherwise configured such that recessed area 106 is disposed within display member 118. In the embodiment illustrated in FIG. 2, portable computer device 104 is operable while disposed within recessed area 106 or, in the alternative, portable computer device 104 is operable while detached from recessed area 106 (e.g., operating based on power provided by an internal power supply such as battery 112).

00231 In the embodiment illustrated in FIG. 2, docking system 102 comprises a locking mechanism 176 configured to secure portable computer device 104 to electronic device 100. In the embodiment illustrated in FIG. 2, locking mechanism 176 releasably secures portable computer device 104 to electronic device 100 in response to insertion of portable computer device 104 within recessed area 106. In FIG. 2, locking mechanism 176 comprises a pair of extendable and retractable extensions 178 and 180 disposed on wall 164 and outwardly biased in the direction of arrow 182 to engage a pair of corresponding recesses 184 and 186 disposed on wall 142 of portable computer device 104. Locking mechanism 176 further comprises a pair of extensions 188 and 190 extending outwardly from wall 166 configured for insertion within pair of corresponding recesses 192 and 194 disposed on wall 144 of portable computer 104. It should be understood that locking mechanism 176 may be otherwise configured (e.g., by providing a greater or fewer number of extensions 178, 180,188 and/or 190, by frictional engagement between portable computer device 104 and recessed area 106, by detents, etc.).

In another embodiment, the locking mechanism 176 can include a magnetic locking mechanism comprising a first magnet disposed on housing 124 of electronic device 100 proximate recessed area 106. A second magnet can be disposed on wall 148 of portable computer device 104 in such a manner that when portable computer device is disposed within recessed area 106, the first and second magnets can be brought together to provide sufficient magnetic force to result in a magnetic physical attraction between portable computer device and electronic device 100. This technique may provide the advantage of reducing the need for proper alignment between the devices.

In operation, to couple portable computer device 104 to electronic device 100, recesses 192 and 194 on portable computer device 104 are aligned with extensions 188 and 190 on wall 166 of recessed area 106 to enable insertion of extensions 188 and 190 within recesses 192 and 194. Once extensions 188 and 190 are inserted within corresponding recesses 192 and 194, portable computer device 104 is positioned such that recesses 184 and 186 on wall 164 of portable computer device 104 are otherwise aligned to receive retractable extensions 178 and 180 on wall 164 of recessed area 106. For example, as portable computer device 104 is inserted within recessed area 106, wall 142 of portable computer device 104 contacts extensions 178 and 180 and otherwise pushes/retracts extensions 178 and 180 inward in the direction of arrow 196 until recesses 184 and 186 are aligned with extensions 178 and 180, respectively. Once aligned, extensions 178 and 180 extend in the direction of arrow 182 for insertion within recesses 184 and 186. Once portable computer device 104 is securely locked in recessed area 106, in one embodiment, electronic device 100 can initiate wireless communication and wireless charging of portable computer device 104, as explained above.

To unlock locking mechanism 176 and remove portable computer device 104 from recessed area 106, an eject button 198 is depressible so as to retract extensions 178 and 180 from corresponding recesses 184 and 186. Once retracted, portable computer device 104 is removable from recessed area 106.

The host RF device 103 can be disposed on electronic device 100 and remote RF device 109 can be disposed on portable computer device 104 to facilitate effective communication between the devices. For example, in one embodiment, host RF device 103 can be disposed within housing 124 and proximate wall 168 of recessed area 106. Likewise, remote RF device 109 can be in disposed in housing 140 and proximate wall 148 of portable computer device 104. In this manner, wireless communication between electronic device 100 and portable computer device 104 can be increased when portable computer device 104 is disposed in recessed area 106. However, it should be understood that host RF device 103 and remote RF device 109 can be disposed on other locations of respective devices 100, 104 for effective communication between the devices.

Likewise, host inductive coupling device 105 can be disposed on electronic device 100 and remote inductive coupling device 111 can be disposed on portable computer device 104 in a manner to facilitate effective charging of battery 112 of portable computer device 104. For example, in one embodiment, host inductive coupling device 105 can be disposed within housing 124 and proximate wall 168 of recessed area 106. Similarly, remote inductive coupling device 111 can be disposed within portable computer housing 140 housing and proximate wall 148. In this manner, wireless charging of battery 112 can be initiated when portable computer device 104 is disposed in recessed area 106. However, it should be understood that host inductive coupling device 105 and remote inductive coupling device 111 can be disposed on other locations of respective devices 100, 104 for effective wireless charging of portable computer device 104 by electronic device 100.

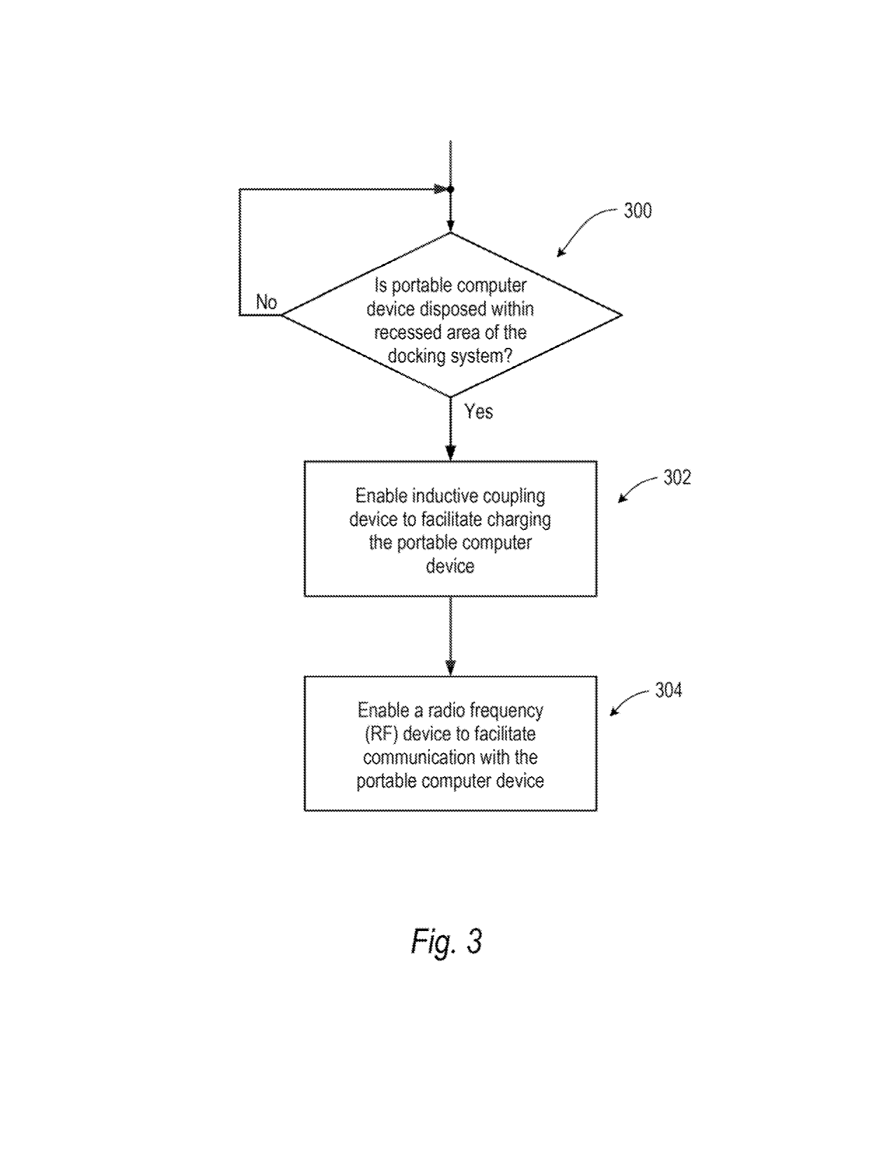

FIG. 3 is a flow diagram of an operation of electronic device 100 employing an embodiment of wireless docking system 102 for portable computer device of 104 FIGS. 1 and 2. At block 300, electronic device 100 checks whether portable computer device 104 is disposed within recessed area 106 of docking system 102. If electronic device 100 determines that portable computer device 104 is disposed within recessed area 106, then the method proceeds to block 302. However, if electronic device 100 determines that portable computer device 104 is not disposed within recessed area 106, then the method proceeds back to block 300 which includes having electronic device 100 continue checking whether portable computer device 104 has been disposed within recessed area 106.

At block 302, electronic device 100 enables host inductive coupling device 105 to facilitate charging of portable computer device 104. As explained above, in one embodiment, host wireless module 108 can be configured to automatically enable host inductive coupling device 105 to facilitate charging of portable computer device 10. The portable computer device 104 can detect the presence of energy from electronic device 100 and process the energy to charge battery 112. In one embodiment, host wireless module 108 can be configured to permit a user to manually enable host inductive coupling device 105 to facilitate charging of portable computer device 104. Once electronic device 100 has enabled inductive charging, the method proceeds to block 304.

At block 304, electronic device 100 enables host RF device 103 to facilitate communication with portable computer device 104. As explained above, in one embodiment, host wireless module 108 can be configured to automatically enable host RF device 103 to facilitate wireless communication with portable computer device 104. For example, electronic device 100 and portable computer device 104 can employ a wireless communication interface (such as Bluetooth®) to facilitate automatic initiation of electronic data communication such as the exchange of data between the devices. The portable computer 104 can employ resources of electronic device such as application programs executing on electronic device 100. For instance, the application programs can allow portable computer device 104 to exchange data with other devices over communication networks such as the Internet. in other embodiments, host wireless module 108 can be configured to permit a user to manually enable host RF device 103 to facilitate wireless communication with portable computer device 104. Wireless communication can be implemented in accordance with various wireless communication techniques, protocols, interfaces, standards such as Bluetooth® and the like.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, are suited to the particular use contemplated. All such modifications and variation are within the scope of this disclosure, as determined by the appended claims when interpreted in accordance with the breadth to which they are entitled.

What is claimed is:

1. A wireless electronic device docking system, comprising:
an electronic device having recessed area disposed on a working surface of the electronic device, the recessed area to receive a portable computer device; and
a wireless module to wirelessly charge the portable computer device when the portable computer device is disposed within the recessed area.

2. The wireless electronic device docking system of Claim wherein the wireless module is further configured to wirelessly communicate with the portable electronic device when the portable computer device is disposed within the recessed area.

3. The wireless electronic device docking system of claim 1, wherein the portable computer device is usable while disposed within the recessed area.

4. The wireless electronic device docking system of claim 1, wherein the portable computer device comprises at least one of an alphanumeric keypad and a touch screen.

5. A wireless electronic docking system of claim 1, further comprising a locking mechanism configured to releasably secure the portable computer device to the electronic device,

6. The wireless electronic docking system of claim 1, wherein the electronic device comprises a radio frequency device to facilitate wireless communication between the portable computer device and the electronic device.

7. The wireless electronic docking system of claim 1, wherein the electronic device comprises an inductive coupling device to facilitate wireless charging of the portable computer device.

8. A method of wireless communication between a portable computer device and a wireless electronic device docking system, the method comprising: generating by the wireless electronic device docking system a wireless signal to charge a portable computer device when the portable computer device is disposed within a recessed area of the wireless electronic device docking system.

9. The method of claim 8, further comprising enabling by the wireless electronic device docking system a radio frequency device to communicate with the portable computer device when the computer device is disposed within the recessed area.

10. An electronic device, comprising:
a display member coupled to a base member to enable variable positioning of the display member relative to the base member, the base member having a recessed area disposed on a working surface of the base member; and
a wireless module to enable wirelessly charging of a portable computer device when the portable computer device is disposed within the recessed area.

11. The electronic device of claim 10, wherein the wireless module is further configured to enable a radio frequency device to wirelessly communicate with the portable computer device when the portable computer device is disposed within the recessed area.

12. The electronic device of claim 19, wherein the portable computer device is usable while disposed within the recessed area.

13. The electronic device of claim 10, further comprising a locking mechanism configured to releasably secure the portable computer device to the electronic device.

14. The electronic device of claim 10, wherein the electronic device comprises a radio frequency device to facilitate wireless communication between the portable computer device and the electronic device.

15. The electronic device of claim 10, wherein the electronic device comprises an inductive coupling device to facilitate wireless charging of the portable computer device.
